(19) United States
(12) Patent Application Publication
(10) Pub. No.: US 2004/0055104 A1
(43) Pub. Date: Mar. 25, 2004

(54) Apparatus and method for cleaning a vacuum system

(76) Inventor: Harold Cutforth, Lethbridge (CA)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/251,764

(22) Filed: Sep. 20, 2002

(51) Int. Cl. B60S 1/64; A47L 5/38

(52) U.S. Cl. 15/347; 15/314

(57) ABSTRACT

An apparatus and method of cleaning a central vacuum system, comprises the steps of removing a debris canister from a suction producing portion of the central vacuum system, tightening a debris bag around the debris canister and then inverting and agitating it to collect debris from the debris canister. The debris bag is next tightened around the suction producing portion and then pushed into the interior of the suction producing portion for wiping the interior. When the system has been cleaned, the dislodged debris is permitted to fall into the debris bag which may be sealed for disposal.

### INCORPORATION BY REFERENCE

Applicant(s) hereby incorporate herein by reference, any and all U.S. patents, U.S. patent applications, and other documents and printed matter cited or referred to in this application.

### BACKGROUND OF THE INVENTION

1. Field of the Invention

This invention relates generally to the cleaning of wall mounted vacuum suction devices used for industrial, commercial and consumer applications (central vacuum systems) and more particularly to a specialty debris bag and method of use of such bag for thoroughly cleaning such a vacuum producing device.

2. Description of Related Art

The following art defines the present state of this field:

Miller et al, U.S. Pat. No. 5,671,983 teaches a storage bag with a sealable top edge and glove shaped side walls for insertion of the hands to manipulate an object within the bag. Browning, U.S. Pat. No. 6,149,252 teaches a glove box having an arm insertion aperture and an open end with surface seal and hole for vacuum hose.

Hoerl, U.S. Pat. No. 6,050,726 teaches a glove bag similar to that of Miller et al and which is sealable using a draw string.

Rittmueller et al, U.S. Pat. No. 5,737,797 teaches a central vacuum system of the type that typically mounts to a wall and provides a dust bin positioned on the bottom.

Surplus, U.S. Pat. No. 5,704,670 teaches a glove bag with an enlarged cuff with sealing means.

Bain, U.S. Pat. No. 4,911,191 teaches a sealing apparatus having dual gloves, a sealing perimeter, vacuum takeoff and pressurized dispenser. A jacking device is used to support the apparatus against a cealing.

Lerner, U.S. Pat. No. 4,788,733 teaches a disposable glove useful as a sealable bag using a draw string when the bag is drawn inside-out to enclose an object to be disposed.

As disclosed above the prior art teaches lockable storage bags (zip-lock types), glove bags and boxes, central vacuum systems with debris catching bags, debris catching apparatus and methods for protection of workers, especially in asbestos related work, and a cleaning glove with drawstring with capacity for catching debris, but does not teach a debris bag and method of use with a suction apparatus for cleaning such apparatus. The present invention fulfills these needs and provides further related advantages as described in the following summary.

### SUMMARY OF THE INVENTION

The present invention teaches certain benefits in construction and use which give rise to the objectives described below.

Central vacuum systems use a suction producing machine that draws dust from various points within a building and deposits the dust into a debris canister. Such a canister must be removed and emptied occasionally. However, this may cause dust clouds to billow up from the canister if it is not handled properly. The present invention provides a superior manner of handling such a debris removal with a sanitary result. The present inventive method of cleaning a central vacuum apparatus comprises the steps of removing a debris canister from a suction producing portion of a central vacuum system, placing an empty debris bag over the debris canister, tightening a draw string of the debris bag to secure a dust-tight joint between the debris bag on the debris canister, and inverting and then agitating the debris canister to cause debris within it to fall from the debris canister into the debris bag. The debris bag is then placed over the suction producing portion of the central vacuum system, the draw string of the debris bag is tightened to secure a dust-tight joint between the debris bag and the suction producing portion, the debris bag is manually pushed into the interior of the suction producing portion and the interior of the suction producing portion is wiped with the debris bag to dislodge further debris. After this, the debris bag is released to allow dislodged debris to fall into it. Finally, the debris bag is released and replaced by the debris canister on the suction producing portion of the central vacuum system. The drawstring is then used to seal the debris bag prior to disposal. The use of a debris bag 40 held by a drawstring around a vacuum machine and its dust receptacle, the inverting and shaking the debris canister to empty its contents into the secured debris bag, and especially, the reaching up inside the suction device to wipe fan blades, walls and other surfaces therein with the same debris bag, appear to constitute a highly novel and very efficient manner for cleaning this sort of machine. In practice the inventor has found that the application of the present method results in inexpensive and superior cleaning as well as very fast results, important to those with many such tasks to accomplish in limited time. It should be noted that prior to reaching into the interior of the suction machine, the possibility of electrical power being turned on should be fully defeated.

A primary objective of the present invention is to provide an apparatus and method of use of such apparatus that provides advantages not taught by the prior art.

Another objective is to provide such an invention capable of cleaning a central vacuum system without raising a dust.

A further objective is to provide such an invention capable of simple application and low cost.

A still further objective is to provide such an invention capable of sanitary disposal of dust and other debris received when cleaning a central vacuum system.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a perspective view of a preferred embodiment of a suction machine of the present invention prior to being cleaned;

FIG. 2 is a perspective view thereof illustrating the manner of emptying a debris canister of the invention method into a debris bag of the invention; and

FIG. 3 is a perspective view thereof illustrating the manner in which a suction portion of the suction machine is engaged with the debris bag and cleaned.

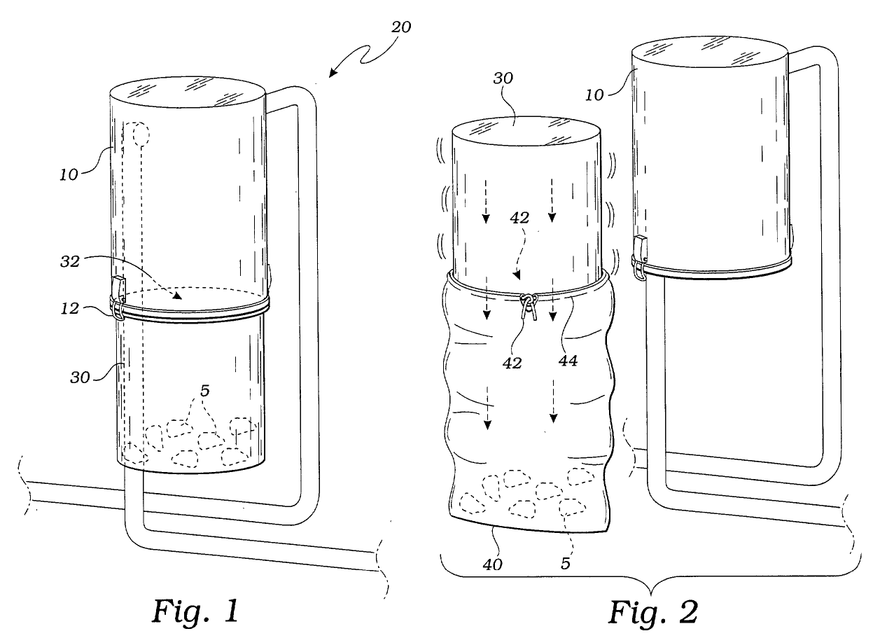

### DETAILED DESCRIPTION OF THE INVENTION

The above described drawing figures illustrate the invention in at least one of its preferred embodiments, which is further defined in detail in the following description.

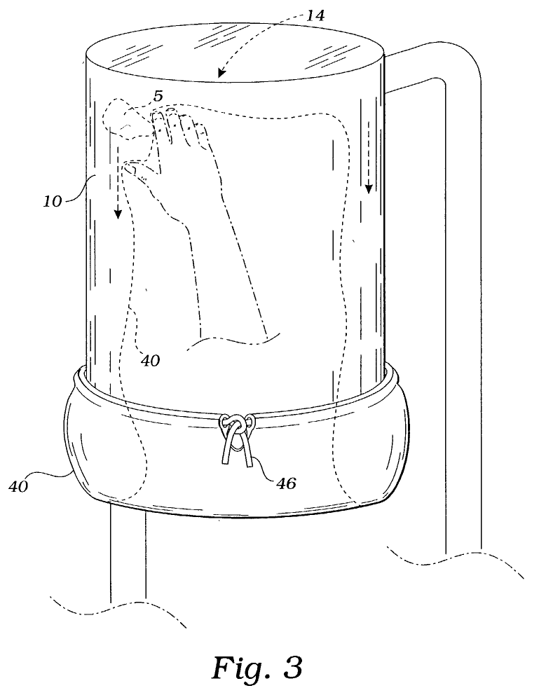

The present invention apparatus comprises in combination, a suction producing portion 10 of a central vacuum system 20 mounted on a vertical wall. A debris canister 30 mounted below the suction producing portion 10, provides a mouth 32 for receiving debris 5 from the suction producing portion 10, the mouth 32 releasably engaged upwardly in a dust-tight relationship with the suction producing portion 10, i.e., dust moves easily between the suction portion 10 and the debris canister 30, but cannot escape to the environment, and such technique is very well known in the art, as taught in the Rittmueller et al reference incorporated by reference. A debris bag 40 preferably of flexible plastic sheet material provides an entrance 42 with a peripheral hem 44, the hem providing a draw string 46 enabled for adjusting the size of the entrance 42 as is well known in the art, and for fully closing the entrance 42, as desired. The entrance 42 is therefore enabled for tight-fitting relationships around the debris canister 30 when the debris canister 30 is released from the suction producing portion 10 by latches 12, See FIG. 2, and also around the suction producing portion 10 of the central vacuum system 20, as shown in FIG. 3. The debris bag 40 is enabled by the draw string 46 for being fully closed for disposal of the debris bag 40 with dust and debris 5 inside.

The method of use of the present invention includes securing dust and debris 5 from the debris canister 30 by removing the debris canister 30 from the suction producing portion 10 of the central vacuum system 20; placing an empty debris bag 40 over the debris canister 30; tightening the draw string 46 of the debris bag 40 to secure the dust-tight joint between the debris bag 40 and the debris canister 30; and, inverting and agitating the debris canister 30 to cause debris 5 to fall from the debris canister 30 into the debris bag 40.

The present method also includes steps for securing dust and debris 5 from the suction producing portion 10, including, as shown in FIG. 3, placing the debris bag 40 over the lower opening (due to removal of the debris canister 30) of suction producing portion 10 of the central vacuum system 20; tightening the draw string 46 to secure a dust-tight joint between the debris bag 40 and the suction producing portion 10; pushing the debris bag 10 manually up and into the interior 14 of the suction producing portion 10; wiping the interior of the suction producing portion with the debris bag 40 to dislodge further debris 5 (FIG. 3); releasing the debris bag 40 to allow dislodged debris 5 to fall into the debris bag 40; and finally, removing the debris bag 40 and replacing the debris canister 30 onto the suction producing portion 10 of the central vacuum system 20.

The drawstring 42 may be tightened to seal the debris bag 40 prior to disposal thereof.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A method of cleaning a central vacuum apparatus comprising the steps of: removing a debris canister from a suction producing portion of a central vacuum system; placing a debris bag over the debris canister; tightening a draw string of the debris bag to secure a dust-tight joint between the debris bag on the debris canister; inverting and agitating the debris canister to cause debris to fall from the debris canister into the debris bag; placing the debris bag over the suction producing portion of the central vacuum system; tightening the draw string of the debris bag to secure a dust-tight joint between the debris bag and the suction producing portion; pushing the debris bag manually into the interior of the suction producing portion; wiping the interior of the suction producing portion with the debris bag to dislodge further debris; releasing the debris bag to allow dislodged debris to fall thereinto; removing the debris bag and replacing the debris canister onto the suction producing portion of the central vacuum system; and tightening the drawstring to seal the debris bag prior to disposal thereof.

2. An apparatus comprising in combination: a suction producing portion of a central vacuum system mounted on a vertical wall; a debris canister providing a mouth for receiving debris from the suction producing portion, the mouth releasably engaged upwardly in a dust-tight relationship with the suction producing portion; a debris bag of plastic sheet providing an entrance with a peripheral hem, the hem providing a draw string enabled for adjusting the size of the entrance and for fully closing the entrance; the entrance enabled for tight-fitting relationships with the debris canister and with the suction producing portion of the central vacuum system when the debris canister is released therefrom, whereby, the bag is engagable with the central vacuum system for receiving debris therefrom and whereby, the entrance is enable for being fully closed by the drawstring prior to disposal of the debris bag.
